(19) United States
(12) Patent Application Publication
(10) Pub. No.: US 2013/0204807 A1
(43) Pub. Date: Aug. 8, 2013

(54) SYSTEMS & METHODS FOR EVALUATION OF ARTICLES OF COMMERCE

(71) Applicant: Mark W. Helweg, Austin, TX (US)

(72) Inventor: Mark W. Helweg, Austin, TX (US)

(21) Appl. No.: 13/836,921

(22) Filed: Mar. 15, 2013

Related U.S. Application Data
(62) Division of application No. 13/485,136, filed on May 31, 2012.
(60) Provisional application No. 61/491,621, filed on May 31, 2011.

(51) Int. Cl. G06Q 40/06

(52) U.S. Cl. CPC G06Q 40/06
USPC 705/36 R

(57) ABSTRACT

The invention is directed to systems and methods for indicating volatility adjusted price information for at least one article of commerce or market therefore, and various tools for providing valuation indicators for both current and historical price activity in terms of valuation rather than absolute price. The invention provides users indicators which quantify the degree in which a market is currently trading at fair value, overvalued or undervalued conditions using enhanced tools.

### CROSS REFERENCE TO RELATED APPLICATION

This application is a divisional of co-pending U.S. application Ser. No. 13/485,136 filed May 31, 2012, which in turn claims the benefit of U.S. Provisional Application No. 61/491,621, filed on May 31, 2011, all of which are incorporated herein by reference in their entirety.

### FIELD OF THE INVENTION

The present invention relates generally to data processing and analysis relating to commodities, market trading or articles of commerce, and more specifically, to computer-implemented systems and techniques for producing enhanced valuation indicators, such as price charts, to allow investors to quickly and easily analyze the relative overbought or oversold state of any market and for generating quantifiable relative overbought, fair value and oversold price levels to drive (feed) automated trading systems or help investors strategically enter or exit markets or purchasing or selling articles of commerce, such as stocks, bonds, financial instruments, commodities or articles of commerce.

### BACKGROUND OF THE INVENTION

In today's fast-paced financial markets, investors need to access information quickly and easily in order to process trading decisions. With the significant growth of online trading, individual investors need effective market analysis tools to help them make better trading decisions. Because the saying “a picture is worth a thousand words” still holds true, traders all over the world rely on traditional bar charts to display both past and present price activity. Bar charts are valuable because they reflect the history of price movement in an easy to process format (a picture.) An investor can literally analyze a chart in a glance. Although bar charts have proven to be valuable tools in the investment field, a frequently asked question is “are traditional bar (price) charts alone the most effective way define relative overbought price levels, relative oversold price levels, or fair value?” As will be shown, price can be displayed in a format which makes is possible to define the relative valuation of any market.

With the advancement in personal computers, the Internet, and online trading, trading in the stock (bonds, and futures) market has significantly increased in popularity. Investors have significant resources to utilize when determining what stock to buy or sell. However, until now, investors have not had a powerful charting tool that can quantify relative value and identify optimal market entry or exit price levels. A market analysis tool that can identify relative overbought and oversold price levels will potentially allow investors to lower their risk exposure (to loss) by helping buyers to enter markets at relatively oversold (undervalued) price levels and sellers to exit markets at relatively overbought (overvalued) price levels. Thus, buying at lower price levels and selling at higher price levels a trader is able to enhance his or her profit potential.

Furthermore, with the recent advancements in computers, many traders are now developing automated and/or mathematical computerized trading systems. These trading systems rely on quantifiable price levels to generate buy and sell signals. Until now, the most common quantifiable price levels used to drive trading systems have been the opening or closing price of a time period (day, week, month, 10-minute bar, etc.). The previous day's (or time period's) highs and lows have also been used as quantifiable reference price levels to direct trading systems to enter or exit markets. Any method or market analysis technique that could expand the number of quantifiable price or value levels to drive automated or mathematical trading systems would be extremely useful to traders, trading services and/or trading system designers.

### SUMMARY OF THE INVENTION

The invention relates to further systems and methods to assist in market analysis and enhancing the systems and methods developed by the applicant. These systems and methods relate to producing information for facilitating the making of a trading decision by an investor. In an example, the system comprises a software program for providing a set of instructions to a computer to receive and process a collection of price data to generate volatility-adjusted relative price data related to the investment. The system generates an indication of a state of a market for the investment as being currently traded at a fair value, as overvalued or undervalued. The assessment of the volatility-adjusted relative price data may be made in relation to dynamic volatility intervals determined for the investment. The system and methods may be used in relation to commodities or other articles of trade, for buying and/or selling purposes. In an example, the system may include market analysis or calculation tools referred to as ValueCharts™ (sometimes hereafter designated “VC”) and Price Action Profile™ (sometimes hereafter designated “PAP”). The tools ValueCharts™ and Price Action Profile™ reveal a hidden order in the markets, and allow a trader at a glance to gain insight into the relative valuation of a market or article of trade. The market, made up of many individual participants, is in a constant search for fair value across every time frame or other variable such as location, type of article of trade or the like. The systems and methods of the invention allow analysis of short-term and long term value. The invention relates to additional systems and methods to utilize the concepts of ValueCharts™ and Price Action Profile™ that for example, will allow a trader to easily and quickly observe valuation levels and determine whether to enter or exit a particular market. Additional systems and methods are provided in relation to such objectives.

### BRIEF DESCRIPTION OF THE DRAWINGS

FIG. 1 shows a daily price chart (top) and relative price chart (bottom) for a particular market.

FIG. 2 shows Example calculations for generating the relative chart of FIG. 1.

FIG. 3 shows a daily price chart (top) and relative price chart (bottom) for another market.

FIG. 4 shows a daily price chart (top) and a ValueCharts™ (bottom) according to an example.

FIG. 5 shows example calculations for generating the ValueCharts™ shown in

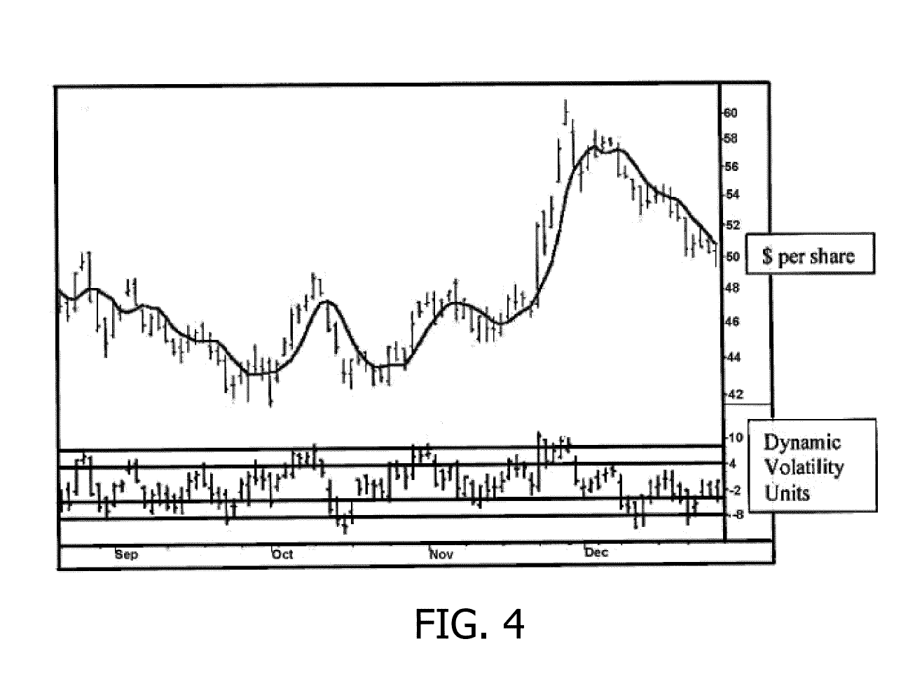

FIG. 4.

FIG. 6 shows a daily bar chart above a daily ValueCharts™.

FIG. 7a shows a daily bar chart above a daily ValueCharts™.

FIG. 7b shows a Price Action Profile™ generated from the daily ValueCharts™ of FIG. 7a.

FIG. 8 displays a traditional price chart with a Probability Bar according to an embodiment of the present invention.

FIG. 9 displays a 60-Minute ValueCharts™ price bars displayed on a daily ValueCharts™ scale.

FIG. 10 displays a Color ValueCharts™ that indicates that a user defined condition or event has occurred.

FIG. 11 displays a traditional price chart with a Bar Flag according to an embodiment of the present invention.

FIG. 12 displays a traditional price chart with a Bar Flag according to an embodiment of the present invention.

FIG. 13 displays Value Bars that reflects the valuation level at each price in conjunction with non-volatility adjusted price data.

FIG. 14 displays a Floating Price Action Profile™ price in conjunction with non-volatility adjusted price data.

FIG. 15 shows a Valuation Overlay that reflects the valuation level at each price in conjunction with non-volatility adjusted price data.

FIG. 16 displays a ValueScan™ Table that allows a user to track and sort markets with respect to their ValueCharts™ price levels.

FIG. 17 displays ValueCharts™ dynamic volatility unit lines on a traditional price chart that displays a Value Zone for a particular market.

FIG. 18 displays ValueCharts™ dynamic volatility unit lines with price bars that reflect a corresponding valuation level that it is trading in.

### DETAILED DESCRIPTION OF EMBODIMENTS

The concepts of the systems and methods of examples of the invention may be usable in conjunction with or independently from identifying relative overbought and oversold price levels of a traded article of commerce, or articles that are bought and sold in a marketplace. In an example, such an indication may be shown in a ValueCharts™ representation, being a graphical or other indication or representation of a trading system indicating trading at a fair value, overvalued or undervalued condition. The concepts of the invention may also be used in automated or mathematical trading system or in other ways. The system generates an indication of a state of a market for the investment as being currently traded at a fair value, as overvalued or undervalued, which can then be used to provide additional indications to assist in trading decisions.

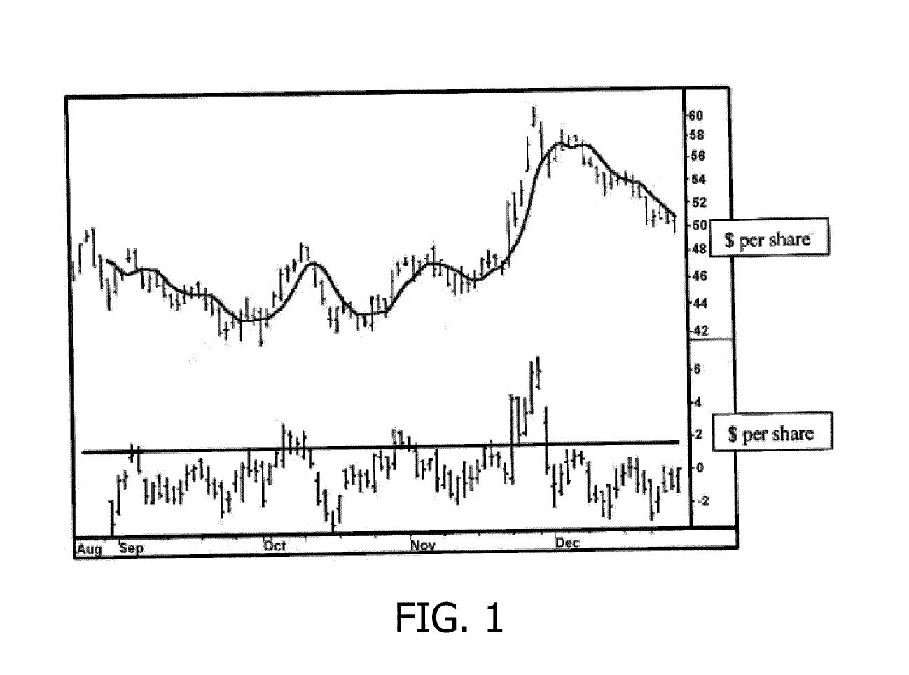

In an example of generating a ValueCharts™, price bars are charted on a relative basis instead of an absolute basis. In this type of chart, such a relative basis may be based on any desired suitable variable, such as a period of time, location or region or otherwise. In an example, a simple 5-day moving average of the median bar chart price for a traded article of commerce as the reference axis. Therefore, instead of plotting price with respect to zero, the price is plotted (open, high, low, close or otherwise) with respect to this simple 5-day median moving average, which may be referred to as the floating axis. Price given in terms of its relation to the floating axis, instead of zero, may be referred to as relative price (see FIG. 1).

As an example, formulas for calculating a relative chart may be selected from any suitable formulas or basis, but for a 5-day median moving average basis, determining the data may use calculating the following: Median Price=(High+Low)÷2; Floating Axis=5-day moving average of Median Price; Relative Price=Price−Floating Axis

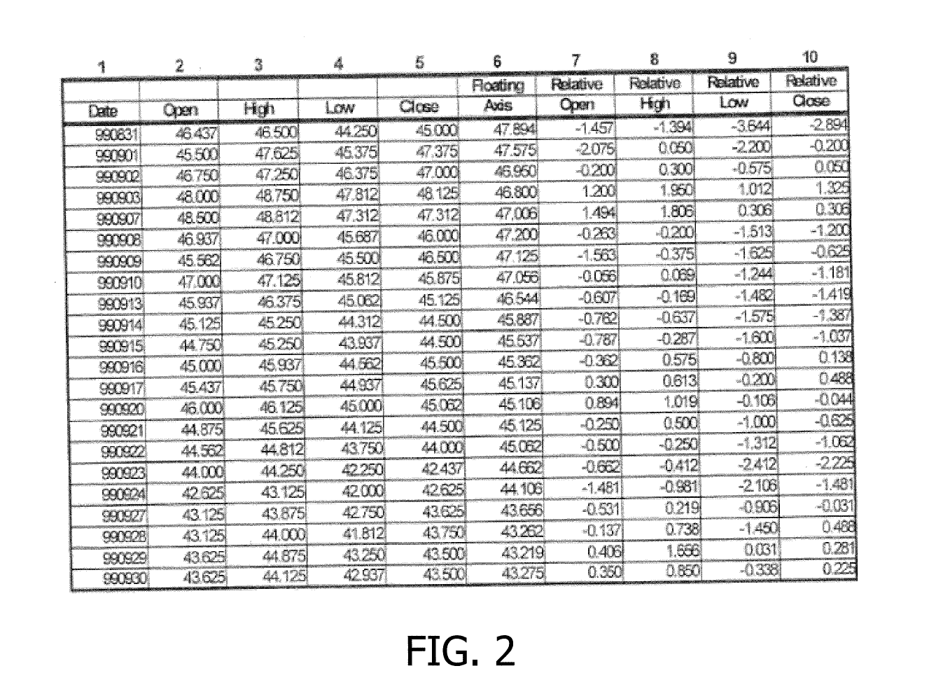

In the example of FIG. 1, the date, open, high, low, and close from the daily bar chart for a stock are listed in the first five columns of FIG. 2. By utilizing the Floating Axis formula displayed above, the Floating Axis may be determined in column 6. From this point, the relative price may be determined (reference FIG. 2). For example, taking the open price in column 2 and subtracting the Floating Axis value in column 6 to get the relative open in column 7. This process may be repeated for the high, low, and close or other parameters into the corresponding relative parameter. For example, from FIG. 2, the relative open for a date (first Row) may be determined as follows:

| Open | | Floating Axis | | Relative Open |
|---|---|---|---|---|
| 46.437 | − | 47.894 | = | −1.457 |

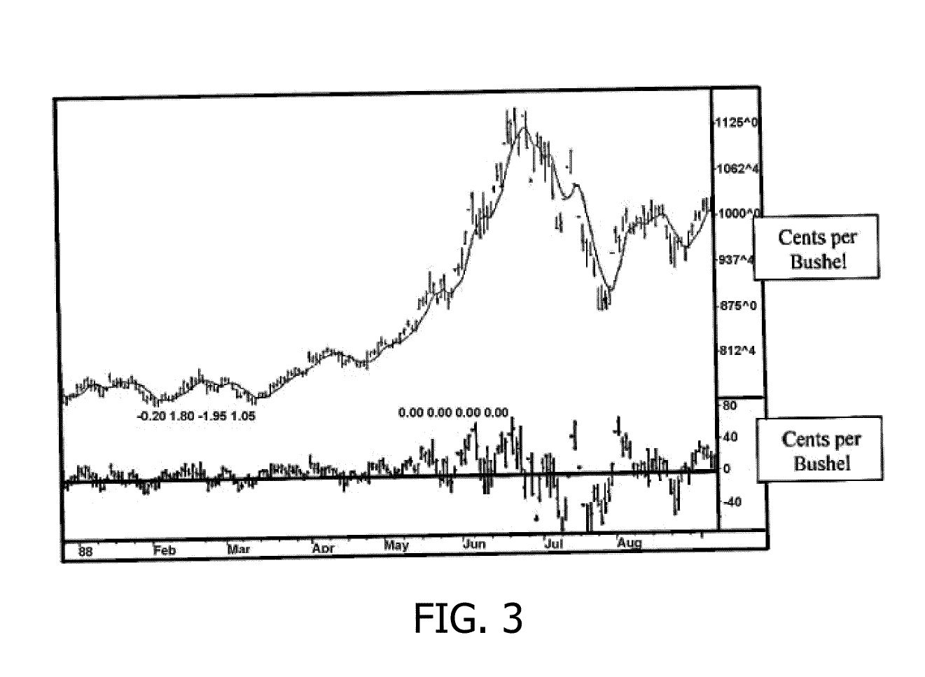

An example of a relative bar chart displayed below a traditional bar chart is shown in FIG. 3. This example, which displays a major bull market, illustrates how volatility can significantly increase as a bull market progresses. The relative chart reflects the relative movement of the market with respect to the floating axis. Upon inspection of the relative chart, it is evident that price tends to deviate more from the zero line (floating axis line) as markets become more volatile. Note that in FIG. 3, as the price became much more volatile on the right side of the chart (June through August timeframe) the relative price bars in the lower chart deviated much farther from the zero axis. As the relative price chart does not adjust to changing volatility conditions, in order for a relative chart to be more useful in identifying overbought and oversold price levels, adapting to changing market volatility is provided. In an example, this may be accomplished by characterizing the data taking into account volatility, such as by providing the y-axis units in the Relative Chart (displayed in FIG. 3) defined in terms of a dynamic volatility unit instead of a static price unit. The dynamic volatility unit allows volatility adjusted relative charts to be generated or to provide an indication in defining relative overbought and oversold price levels as market volatility changes over time. The volatility adjusted relative indicators, such as charts, may be referred to as ValueCharts™.

In an example, the dynamic volatility unit (DVU) may be defined in any suitable manner, to account for volatility. In line with the example above, the DVU may be characterized as 20% of the 5-day average of the volatility measurement (VM). The VM may be defined in any suitable manner, and as an example, as either the daily price range (High−Low) or today's close minus yesterday's close (C−C[1]), whichever is larger.

As merely an example of a developing an indication of trading at a fair value, undervalued or overvalued condition, a chart, which may be referred to as a ValueCharts™, is formed using data adjusted for volatility. Calculations may use any suitable techniques to account for volatility, but as an example, the following formulas may be used:

Floating Axis=5-day moving average of ((High+Low)÷2);

for determining Dynamic Volatility Units (DVU)—

If (High−Low)>(Close−Close[1]) then VM=(High−Low)

If (High−Low)<(Close−Close[1]) then VM=(Close−Close[1])

(Close−Close[1] means today's close minus yesterday's close for example)

Dynamic Volatility Units (DVU)=(5-day moving average of VM)*0.20

Value Price=(Price−Floating Axis)÷DVU

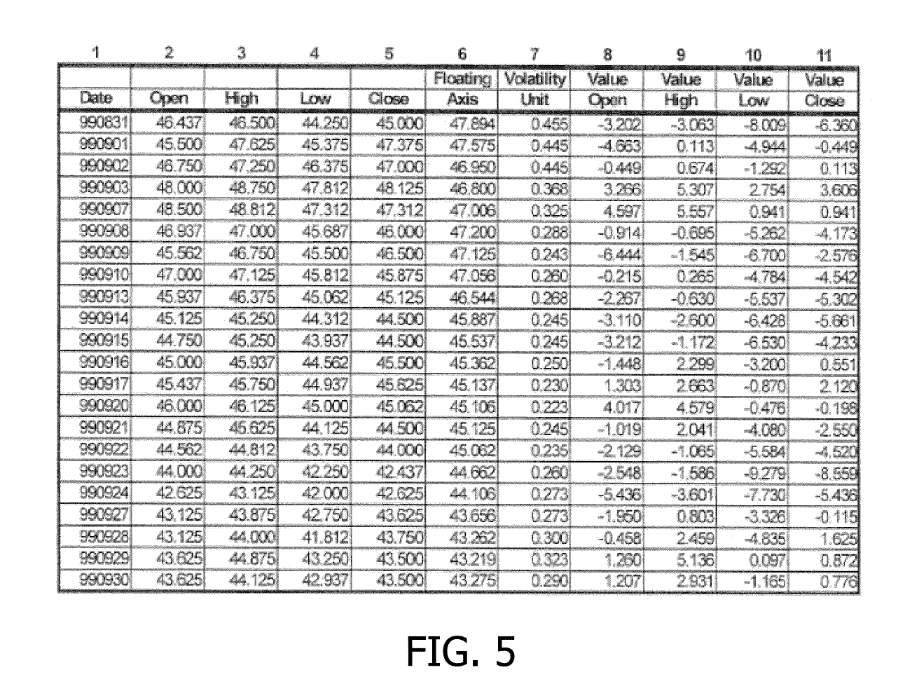

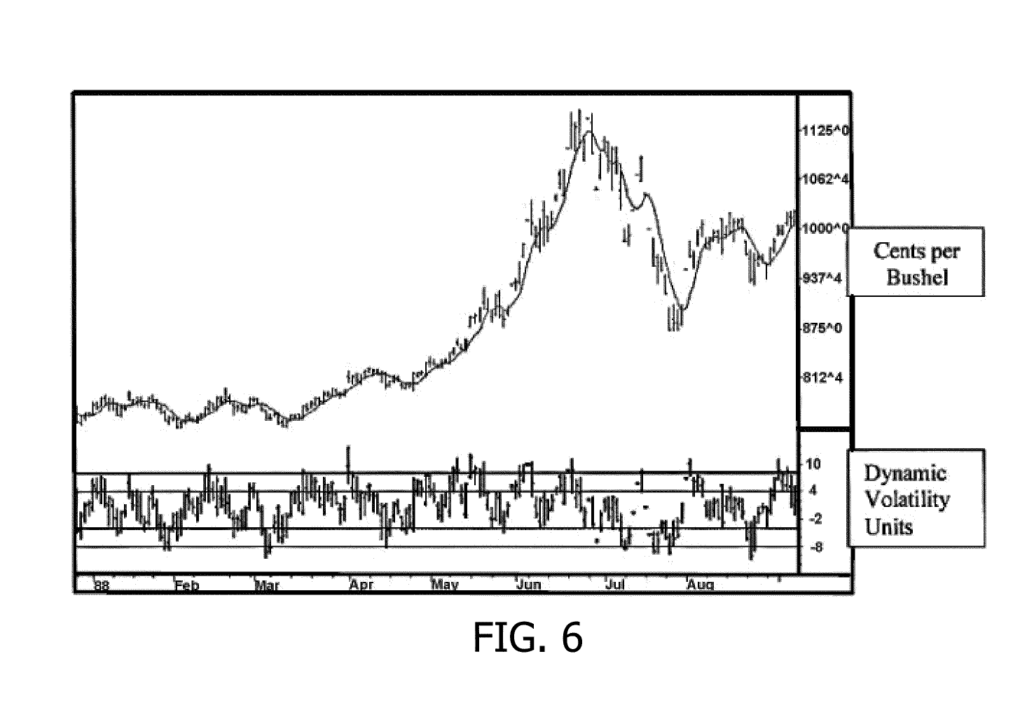

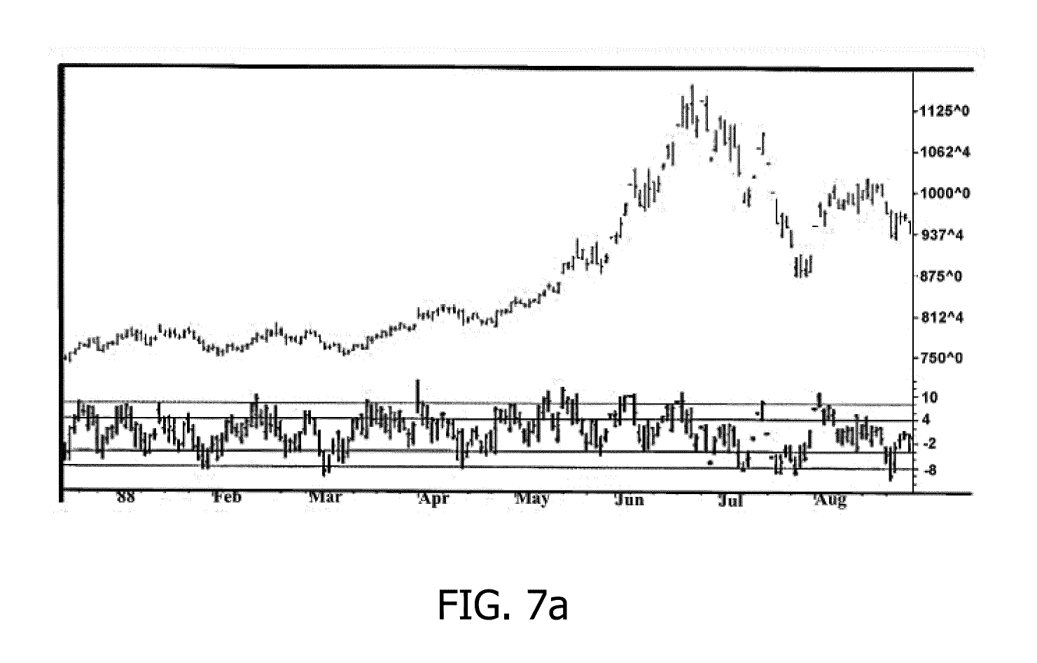

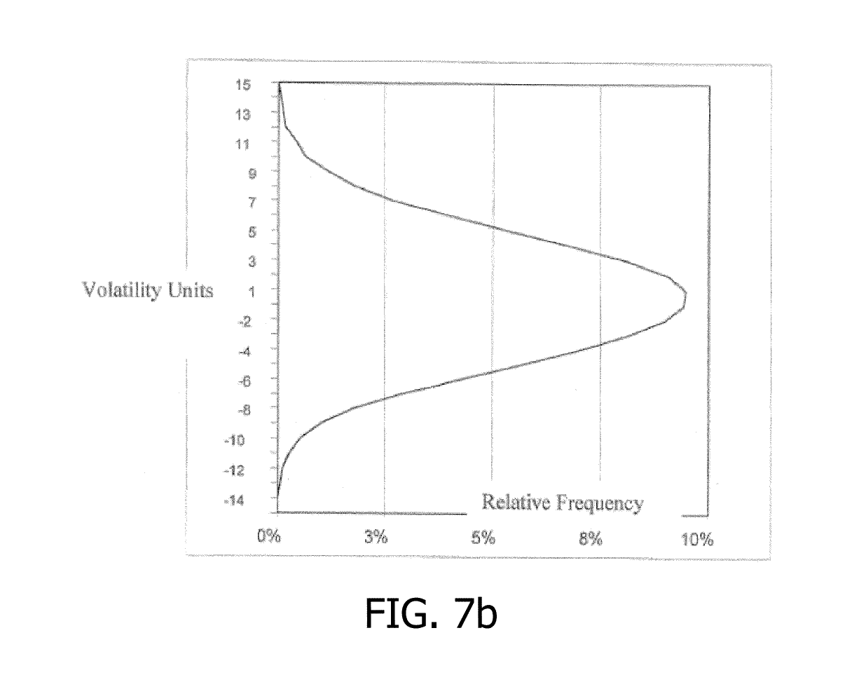

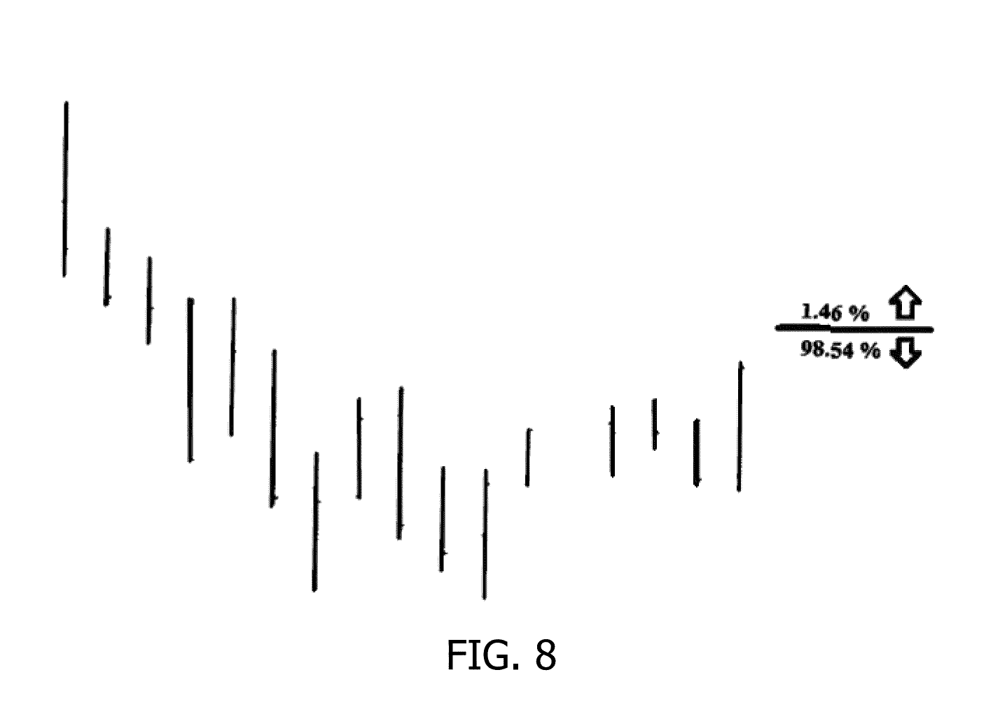

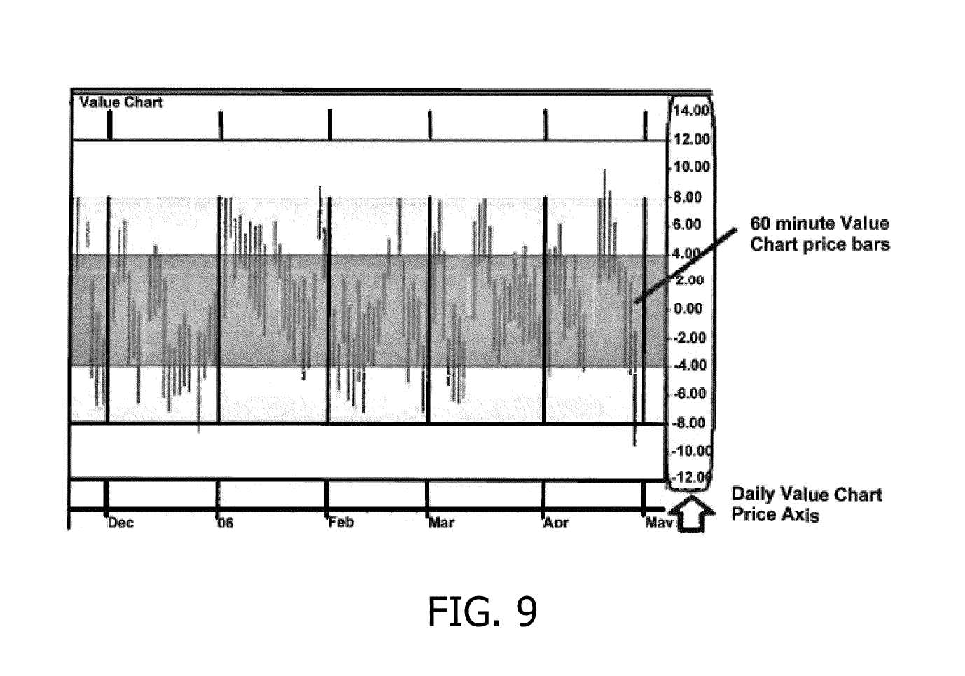

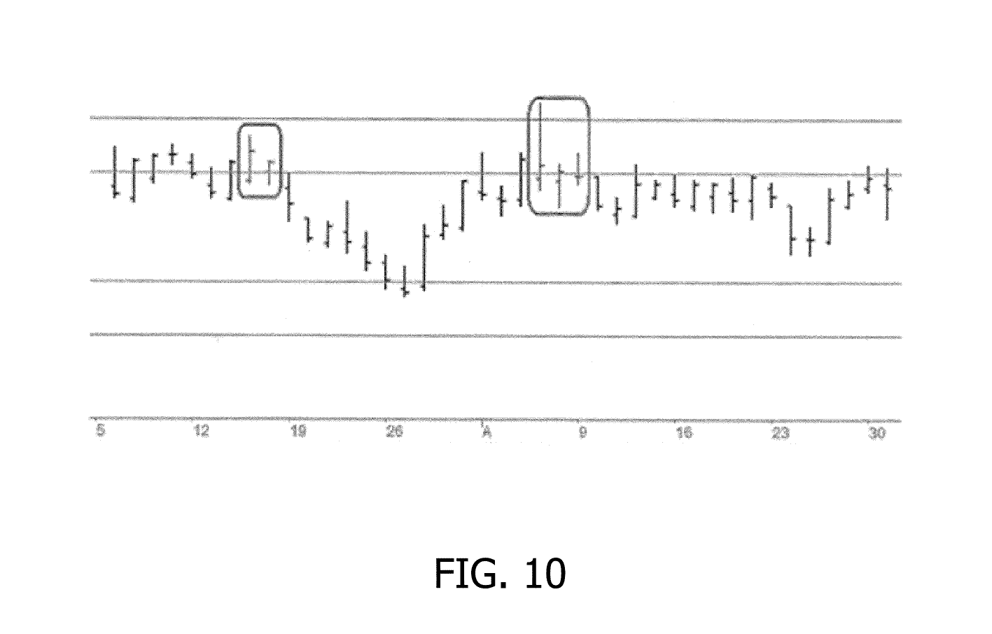

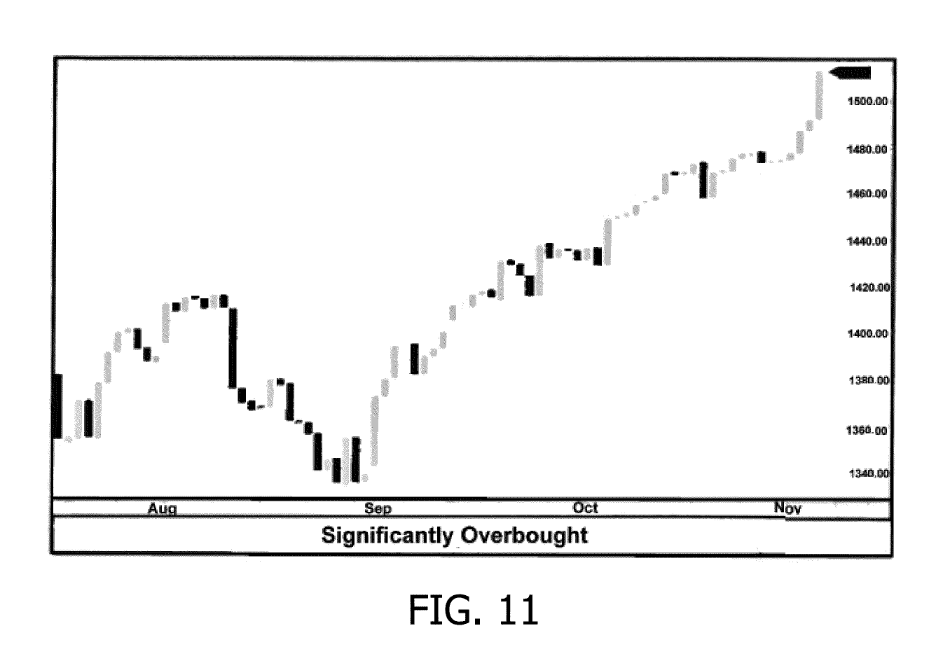

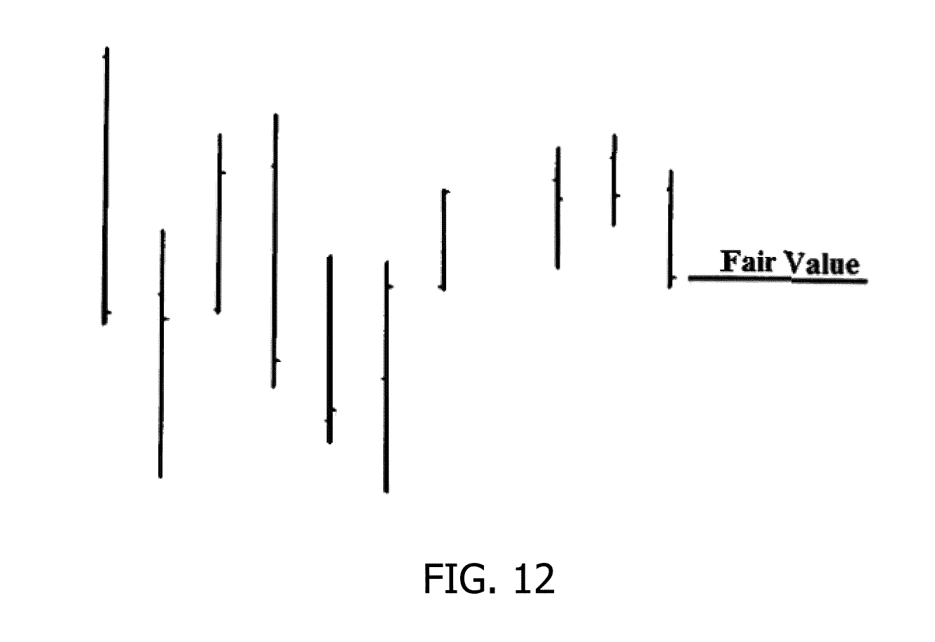

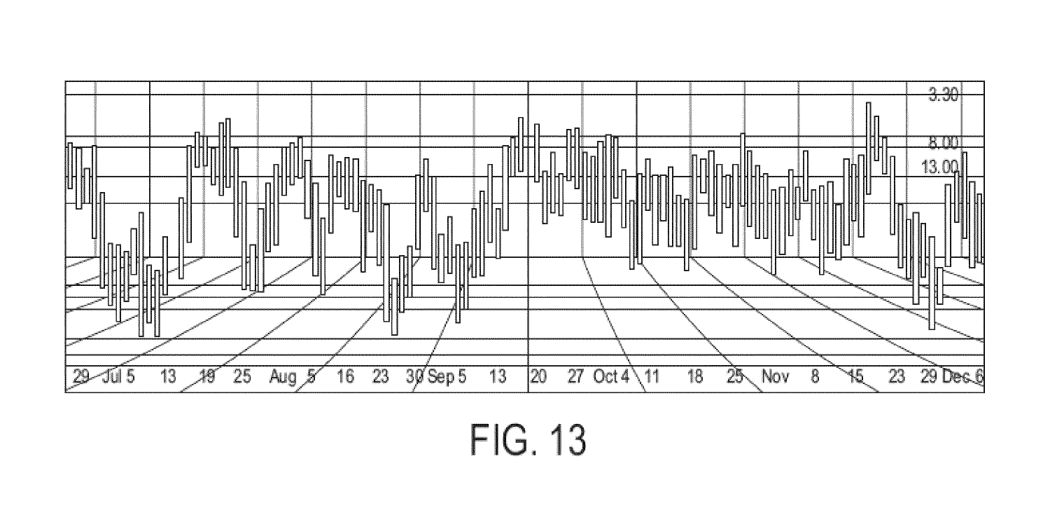

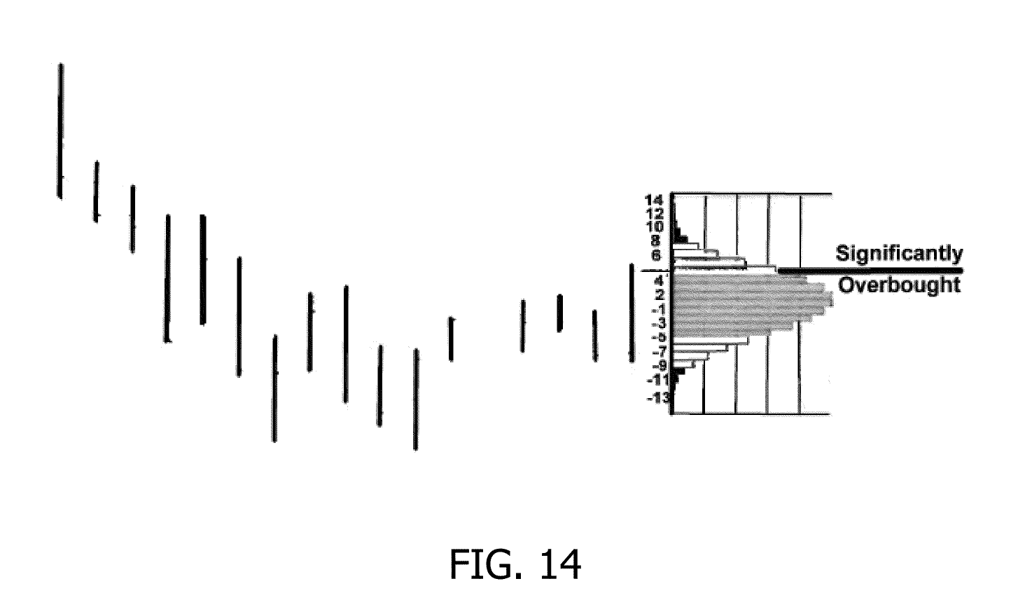

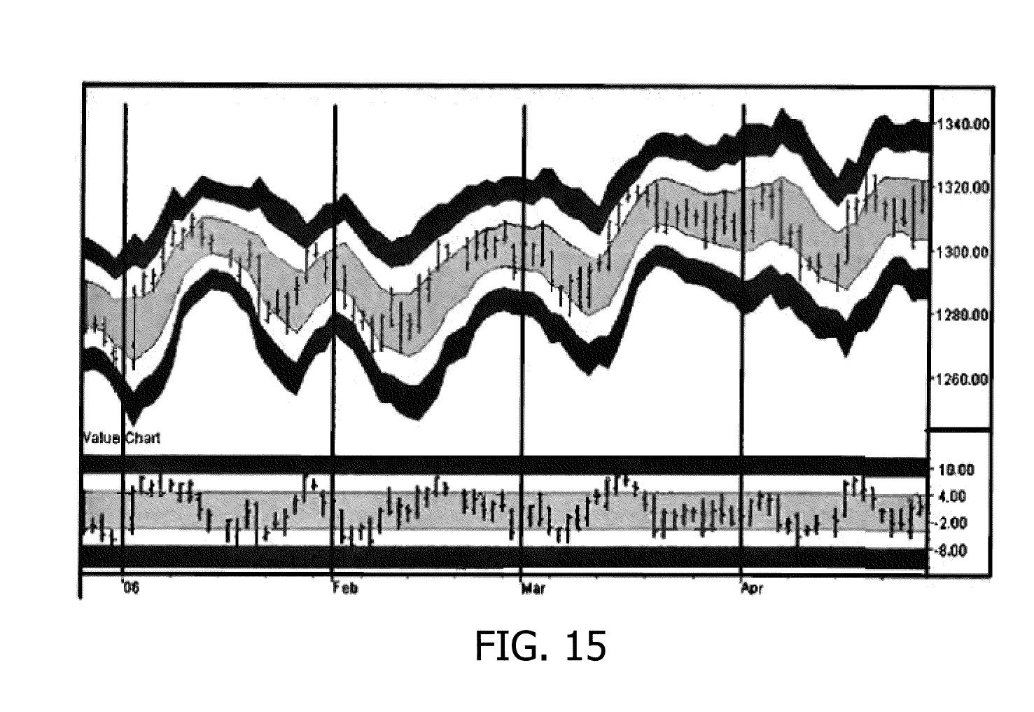

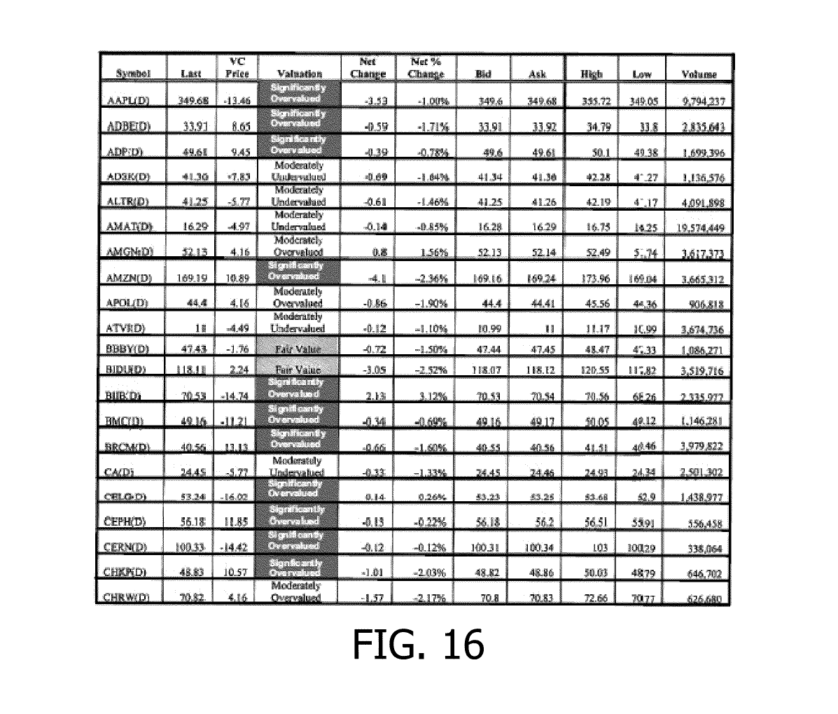

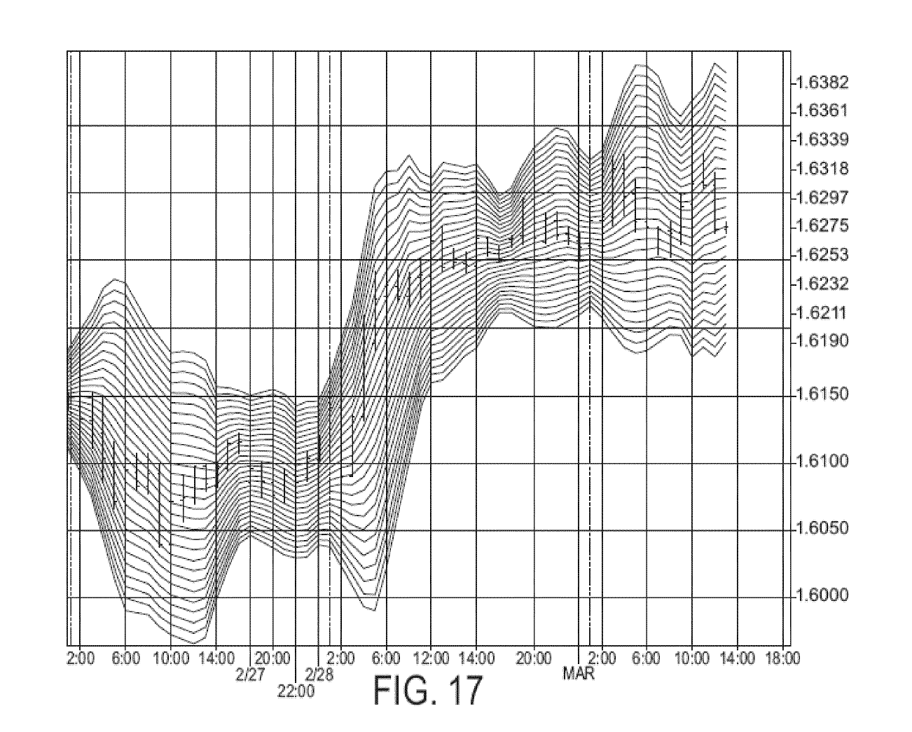

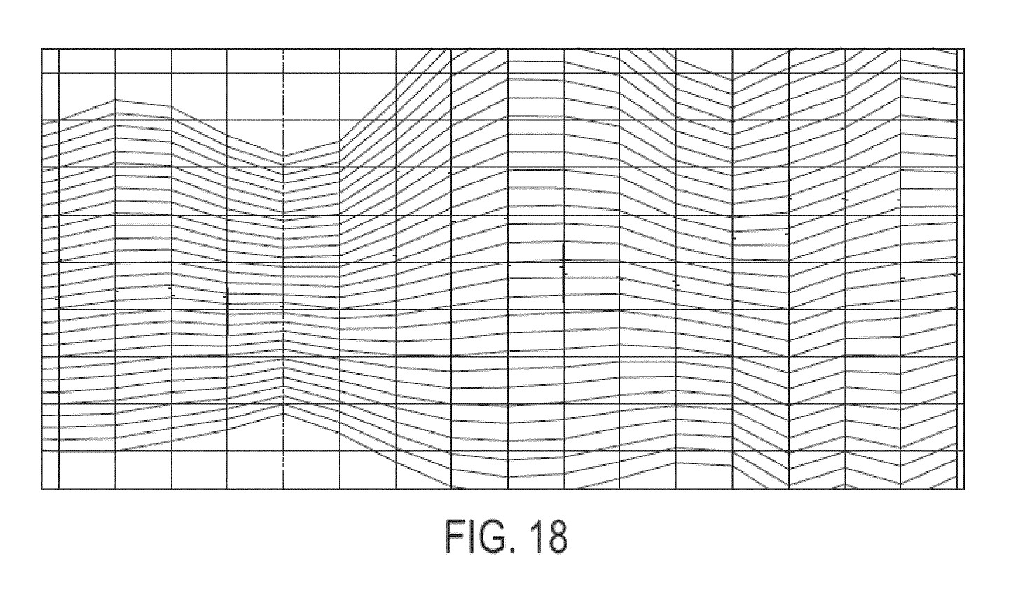

As an example, the date, open, high, low, and close of the daily bar chart (as seen in FIG. 4) are listed in the first five columns of FIG. 5. By utilizing the Floating Axis formula, the Floating Axis is calculated in column 6 (refer to FIG. 5 for example calculations). By utilizing the Dynamic Volatility Unit formula, the Dynamic Volatility Unit (Volatility Unit) in column 7 (of FIG. 5) is calculated. From this point calculating a ValueCharts™ price is determined for example, by taking the open value in column 2 and subtracting the Floating Axis value in column 6, and then dividing this value by the Dynamic Volatility Unit in column 7 provides an example volatility adjusted or ValueCharts™ Open price in column 8. Repeating this process for the high, low, and close to calculate the volatility adjusted ValueCharts™ High, Low, and Close.

From FIG. 5 more particularly, the volatility adjusted Open can be calculated as follows:

| | | Floating | | | | |
|---|---|---|---|---|---|---|
| Open | | Axis | | Volatility Unit | | ValueCharts Open |
| (46.437 | − | 47.894) | ÷ | 0.455 | = | −3.202 |

This example provides one suitable way to convert the traditional daily price chart, such as in the top of FIG. 3, into a volatility adjusted relative price chart, or ValueCharts™ (FIG. 6). As is seen in FIG. 6, the volatility adjusted relative price chart is effective in adjusting to changing volatility levels in the bull market. This or other suitable methods allow an indication different levels of volatility in any market and effectively define overbought and oversold relative price levels at these different levels. It should be understood that other suitable methods of volatility adjustment are contemplated within the scope of the invention.

Further concepts to enhance the ability for traders to enter and exit markets at better, or more profitable, price levels, and provide the ability for online brokerage services to offer automated trading services based on one or more ValueCharts™ price levels or other information will be described. Traders or others can now design and implement trading systems that enter or exit markets at volatility adjusted or ValueCharts™ price levels. Because ValueCharts™ works the same across every market by using the same universal overbought and oversold point scale, trading strategies no longer have to be revised to accommodate each unique market.

It is also provided that the volatility adjusted data developed can be used to provide a profile, or bell curve, that describes the historical behavior of volatility adjusted price information. These Profile may be referred to as Price Action Profile™ that display how frequently a ValueCharts™ has traded above, below, or in any given ValueCharts™ sector. Such a profile reflects the distribution of price information such as represented in price bars, in the different volatility intervals. The Profile may be generated by any suitable methods, and as an example, using the volatility adjusted price and trading data, the number of bars of a ValueCharts™ that trade in each volatility interval may be used to stack into the profile. For example, if there are first three bars in the ValueCharts™ trade in the (+1) volatility interval, the profile or Price Action Profile™ reflects this by having three layers in the (+1) volatility interval. As price bars are added to the ValueCharts™, the Price Action Profile™ will continue to stack these bars and eventually form the shape of a bell curve.

In an example, a Price Action Profile™ is generated for the ValueCharts™ displayed in FIG. 7a. The chart in FIG. 7a displays about nine months of price datum. A profile may be developed from this or from more extensive volatility adjusted price activity. Again, building a profile may be done by other suitable methods but may utilize stacking or sliding all of the ValueCharts™ daily price bars to the left. In this example, approximately 30 years of price datum was used to develop the frequency diagram or bell curve of ValueCharts™ price activity (displayed in FIG. 7b). Because the Price Action Profile™ in FIG. 7b closely resembles a normal bell curve, a trader can make inferences about the population (future prices) by analyzing this bell curve. As should be evident, having insight on the future price behavior of any market can lead to trading profits. By analyzing the Price Action Profile™, the trader can quantify the frequency in which the market trades in each ValueCharts™ interval.

As previously indicated, any type of price datum, including, but not limited to, tick charts, bar charts, candle stick charts, point & figure charts, any type of price charts, technical charts and charting indicators, price data of articles of trade or any other suitable datum, can be converted to volatility adjusted price data and used to provide an indication of value according to the invention. Similarly, the invention may substitute traditional time based price bars in the reference price chart or the like with non-time based prices bars (like tick bars) within the traditional price chart that is used to calculate the volatility adjusted data such as for ValueCharts and Price Action Profile. Other non-time based price bars or price points can also be considered.

The floating axis can be defined as any function of price. The distance that price lies away from the floating axis is directly related to the degree of buying and selling that has come into the market at that time. This may be designated F as the function that generates the floating axis values. The function (F) may be preset or is user defined and can be any function of price. In the example, F is defined as a five-day moving average of the median price in each of the five latest price bars. ValueCharts™ can be easily customized because the user has the capability to use any function of price for the floating axis. The sensitivity to price change that the user desires may be used to select how many price data points (such as price bars) will be taken into consideration in the calculation. The ability to customize the function for the floating axis gives the user the power to tailor Price Action Profile™ and ValueCharts™ to desired specifications. Although any suitable calculation may be used, an exemplary floating axis calculation may be:

M=Median Price=(H+L)/2

F=Floating Axis Function=(M+M[1]+M[2]+M[3]+M[4])/5

Brackets denote number of days ago: [Number of days ago]
Example: M[1]=Median price from one day ago (yesterday)
Once the floating axis has been defined, as described, an interval to represent the volatility adjustment, such as a unit value on the y-axis, which may be referred to as a Dynamic Volatility Unit™, is determined. This volatility adjustment may be used to indicate the relative value of an article of trade, and in an example, used to define the point value for the representation of the market, such as via ValueCharts™ for example. This interval can be any function of price. However, these dynamic intervals may be designed to expand and contract along with changing market volatility. This interval function may be designated as function (DVU). Like the function F for the floating axis, the function DVU may be user defined and can be any function of price. For our example, the DVU may be defined as a function that generates a dynamic volatility unit by taking a five-day moving average of a bar's trading range (H−L) or today's close minus yesterday's close, whichever is greater, and then dividing this value by 5. Although any suitable calculation may be used, an exemplary interval or Dynamic Volatility Unit™ calculation is as follows:

R=(Price Range)=(H−L) or (C−C[1]) {The greater of the two values}

A=Average 5-Day Price Range=(R+R[1]+R[2]+R[3]+R[4])/5

DVU=Dynamic Volatility Unit=A/5

Brackets denote number of days ago: [Number of days ago]
Example: R[1]=Price Range one day ago (yesterday)

The system and methods may generate a graphical representation as shown, and assume that the x-axis will reflect time, but other indicators or variables may be used. The y-axis on may be defined in terms of volatility units. The x-axis on Price Action Profile™ will be defined in terms of DVUs. The y-axis of Price Action Profile™ will be defined as a percentage of the relative frequency of occurrences of ValueCharts™ price bars contained in each corresponding dynamic volatility unit. Further information and applications regarding the systems and methods developed by the applicant, relating to producing information for facilitating the making of a trading decision by an investor are set forth in U.S. Pat. No. 7,461,023, which is hereby incorporated by reference. In an example, the system comprises a software program for providing a set of instructions to a computer to receive and process a collection of price data to generate volatility-adjusted relative price data related to the investment. The system generates an indication of a state of a market for the investment as being currently traded at a fair value, as overvalued or undervalued.

Referring to FIG. 8, a further concept is provided, and in this example is represented by a traditional price chart displayed with an indicator to show the probability of a market reaching a certain level or range, that may be referred to as a Probability Bar™. The Probability Bar™ may be positioned horizontally and to the right of a current bar, and is shown next to a final bar in FIG. 8. The Probability Bar™ indicates, as percentages, the probability of the market reaching a certain price level according to corresponding ValueCharts™ and/or Price Action Profile™ calculations. The percentage value above the Probability Bar™ line may represent the percentage of trading activity that historically occurred above the Probability Bar™ line and the percentage value below the Probability Bar™ line may represent the percentage of trading activity that historically occurred below the Probability Bar™ line. As a user vertically repositions the Probability Bar™, the numbers or percentages associated with the Probability Bar™ may automatically update according to the trading activity that would occur above or below the price level as identified by the Probability Bar™. Additionally, the block-arrows above and below the Probability Bar™ may be color coordinated according to the valuation zone that the Probability Bar™ is located in, such as “red” for “extremely overbought,” “yellow” for “moderately overbought,” and “green” for “fair value.” The Probability Bar™ may also be overlaid in conjunction with a Price Action Profile™ or a ValueCharts™. Other suitable indicators may be used for communicating such information.

Referring to FIG. 9, a shorter duration (such as 60-Minute) ValueCharts™ price bars are displayed on a longer duration (such as daily) ValueCharts™ scale, e.g. price axis. This allows a user to view shorter term price patterns/bars that are displayed on an axis of a longer timeframe, e.g. a daily ValueCharts™. This may be helpful in determining intra-day trends and/or reversals. For example, instead of viewing one daily ValueCharts™ price bar, an investor can view twenty four “24” 60-minute price bars that traded within the one daily price bar range. A daily Dynamic Volatility Unit™ may be used in calculating and determining the position of the 60-minute ValueCharts™ price bars for the distance that each 60-minute price bar is positioned with respect to the zero ValueCharts™ axis. FIG. 9 displays shorter term ValueCharts™ price bars at the ValueCharts™ y-axis price levels of a longer term ValueCharts™. Other suitable representations or communication of such information may be used.

Referring to FIG. 10, a display of information based on volatility adjusted data correlating to an event may be provided, and may be referred to as a Event or Color ValueCharts™, which indicates that a user or investor defined condition or event has occurred. The Color ValueCharts™ may also include price bars of different colors in order to indicate that a particular condition has been met or that an event has occurred. Other methods or techniques to indicate that a particular condition has been met or that an event has occurred are contemplated and may be used, such as an audible, visual or other signal. Upon a particular condition being met or an event occurring, a message may also be sent to a user via any suitable method, such as email, texting and other suitable forms of communication. For example, FIG. 10 displays two events that have occurred and are circles/boxed. These circles/boxes may also be the same color as the price bars located within. Other variations are contemplated, and other suitable representations or communication of such information may be used.

In FIG. 11, the traditional price chart may include a Bar or Value Flag, which communicates or indicates the ValueCharts™ valuation level. The Bar Flag is shown towards the end of the traditional price chart as a block-arrow, but any suitable indicator may be used. The Bar Flag may be next to the current price level at the right most portion of the traditional price chart. A user may utilize the Bar Flag to indicate the valuation zone that the corresponding traditional bar chart is trading within. Additionally, the Bar Flag may be color coordinated according to the valuation zone that the Bar Flag is located in, such as “red” for “extremely overbought,” “yellow” for “moderately overbought,” and “green” for “fair value.” A Bar Flag is also displayed with a traditional price chart in FIG. 12 which communicates or indicates the ValueCharts™ valuation level.

As an alternative, as seen in the example of FIG. 13, a representation of value according to the invention, which may be referred to as ValueBars™, are displayed, which may be traditional price bars that are colored or otherwise modified to reflect the valuation level that each price, within a given price bar, is trading at. Utilizing volatility adjusted price intervals that may be positioned above and below a given mean price level, valuation zones can be defined with different colors, such as green, yellow, and red, and labels as “price zones” at defined volatility adjusted distances above or below the mean. Price levels adjacent to the mean may be defined as “fair value” and “green.” Price levels further below the mean may be defined as “moderately undervalued” and further “significantly undervalued,” and respectively colored “yellow” and “red.” Price levels further above the mean may be defined as “moderately overvalued” and further “significantly overvalued,” respectively colored “yellow” and “red.” Each volatility adjusted valuation level may be assigned a specific color and assigned a specific level. Furthermore, ValueBars™ may be plotted with a corresponding color assigned to each volatility adjusted relative price level, with the shading indicative of different colors as shown by the shading in FIG. 13. Users or investors may view traditional price charts and determine the valuation level of a market by observing the color or other indicator of the current price level within a price bar. Investors may also view past price history information and determine the valuation level of prices within a given price bar by simply observing the colors associated with the corresponding portion of the associated price bar. Other variations are contemplated, and other suitable representations or communication of such information may be used.

Referring to FIG. 14, a Floating Price Action Profile™ is displayed in conjunction with a traditional price chart. A Bar Flag™ may also be utilized to indicate a valuation zone that the corresponding traditional bar chart is trading within. By initiating the Floating Price Action Profile™, an investor may utilize the corresponding Price Action Profile™ with the associated traditional price chart. Other variations are contemplated, and other suitable representations or communication of such information may be used.

As a further alternative, as seen in the example of FIG. 15, a Valuation Overlay is displayed. The Valuation Overlay may be a series of volatility adjusted relative price levels positioned around a mean price level and then overlaid on top of a traditional bar chart. The Valuation Overlay may allow an investor to determine the magnitude at which a market is overvalued or undervalued by observing when and where the relative volatility adjusted price level (zone) of the market is trading above, below, or near the mean. The relative volatility adjusted price zones may also be assigned colors that correspond to a particular valuation, which allows the investors to easily recognize the degree at which a market is overvalued or undervalued. In each of the above examples, the valuation indicator based on volatility adjusted price data is provided an indication of valuation of the article of commerce as trading at a fair value, undervalued or overvalued state of the market in association with price information which is not volatility adjusted related to the article of commerce. Other variations are contemplated, and other suitable representations or communication of such information may be used.

Referring to FIG. 16, a valuation indicator, which may be referred to as ValueScan™ is displayed in a table form. The ValueScan™ table may be provided as a tool that allows a user or investor to track and sort a large array or number of markets in terms of their relative volatility adjusted price level or market valuations. This may allow the investor to manage and track several hundred, or even several thousand, stocks or markets within a given window. The ValueScan™ table also may allow the investor to search for and easily identify markets that may have reached a certain valuation state, such as “significantly undervalued/overvalued” that is marked, such as in the color “red,” “moderately undervalued/overvalued” that is marked in the color “yellow,” and “fair value” that is marked in the color “green.” Other variations are contemplated such as geographical oriented scanning of overseas markets, type of markets and other suitable representations or communication of such information may be used.

Referring to FIG. 17, ValueCharts™ Dynamic Volatility Unit™ lines are displayed on a traditional price chart. This assists a user in determining the Value Zone of a particular market was or is trading in. The ValueCharts™ Dynamic Volatility Unit™ lines may also be colored or otherwise presented to communicate the valuation level that it is trading in. Other variations are contemplated, and other suitable representations or communication of such information may be used.

Referring to FIG. 18, ValueCharts™ Dynamic Volatility Unit™ lines are displayed with price bars that reflect a corresponding valuation level that it is trading in. The price bars may be color coordinated or the like at each segment of the price bar in order to communicate the valuation level that it is trading in. As shown in FIG. 18, portions of the price bars in the price chart have different valuation ranges with corresponding valuation colors, such as “green,” “yellow,” and “red” for example. Other variations are contemplated, and other suitable representations or communication of such information may be used.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A system for facilitating the making of a trading decision relative to an article of commerce, said system comprising:
a programmable computer having a central processing unit (CPU);
a communication device linked to said computer for receiving a collection of price data relating to an investment from a data source;
a software program for providing a set of instructions to said computer to receive and process said collection of price data related to the article of commerce to generate volatility-adjusted relative price data related to the article of commerce and to generate an indication of a state of a market for the article of commerce as being currently priced at a fair value, as overvalued or as undervalued;
the software program providing information for communicating price information which is not volatility adjusted related to the article of commerce and having an indication of valuation of the article of commerce as trading at a fair value, undervalued or overvalued state of the market determined from volatility adjusted price information.

2. The system of claim 1, wherein traditional price bars are provided with an indication of valuation of the article of commerce as trading at a fair value, undervalued or overvalued state of the market determined from volatility adjusted price information.

3. The system of claim 2, wherein the traditional price bars are colored or modified to reflect the valuation level that each price, within a given price bar, is trading at.

4. The system of claim 1, wherein the software program utilizes volatility adjusted price intervals positioned above and below a given mean price level, and generating valuation zones defined with different indicators.

5. The system of claim 4, wherein the different indicators are different colors.

6. The system of claim 4, wherein the different indicators are volatility adjusted valuation levels.

7. The system of claim 6, wherein each volatility adjusted valuation level is assigned a specific color and assigned a specific level.

8. The system of claim 4, wherein the different indicators are a plurality of bars displayed in a graphical form, and plotted with a corresponding color assigned to each volatility adjusted relative price level, with shading within the bars indicating volatility adjusted valuation levels.

9. The system of claim 1, wherein traditional price charts are provided with an indication of volatility adjusted valuation levels within a price bar.

10. The system of claim 9, wherein the traditional price charts provide past price history information and an indication of the valuation level of prices within a given price bar using colors indicative of valuation of the article of commerce as trading at a fair value, undervalued or overvalued state of the market determined from volatility adjusted price information, associated with the corresponding portion of an associated price bar.

11. The system of claim 1, wherein a Floating Price Action Profile™ is displayed in conjunction with a traditional price chart.

12. The system of claim 1, wherein a flag indicator is displayed in conjunction with a traditional bar chart to indicate a valuation zone that the corresponding traditional bar chart is trading within.

13. The system of claim 1, wherein a series of volatility adjusted relative price levels positioned around a mean price level are overlaid on top of a traditional bar chart.

14. The system of claim 13, wherein the series of volatility adjusted relative price levels positioned around a mean price level are overlaid on top of a traditional bar chart allow for determining the magnitude at which a market is overvalued or undervalued by observing when and where the relative volatility adjusted price level or zone of the market is trading above, below, or near the mean.

15. The system of claim 13, wherein the overlaid information includes assigned colors that correspond to a particular valuation.

16. The system of claim 1, wherein the valuation indicator is displayed in a table form.

17. The system of claim 1, wherein the table allows tracking and sorting of a large array or number of markets in terms of their relative volatility adjusted price level or market valuations.

18. The system of claim 1, wherein lines corresponding to calculated dynamic volatility units are displayed on a traditional price chart.
